(19) United States
(12) Patent Application Publication
(10) Pub. No.: US 2025/0146986 A1
(43) Pub. Date: May 8, 2025

(54) METHOD FOR DETERMINING CONTENT OF OLAFLUR IN TOOTHPASTE BY LIQUID CHROMATOGRAPHY-TANDEM MASS SPECTROMETRY

(71) Applicants: Zhejiang Institute of Quality Sciences, Hangzhou (CN); Hangzhou Island Xingqing Biotechnology Co., Ltd., Hangzhou (CN)

(72) Inventors: Hongyan Li, Hangzhou (CN); Yan Lu, Hangzhou (CN); Wulian Chen, Hangzhou (CN); Jiong Li, Hangzhou (CN); Jin Wang, Hangzhou (CN); Huizhong Zhou, Hangzhou (CN)

(21) Appl. No.: 19/017,493

(22) Filed: Jan. 11, 2025

(30) Foreign Application Priority Data
Jun. 27, 2024 (CN) 202410840503.3

(51) Int. Cl. G01N 30/72; G01N 30/04; G01N 30/06; G01N 30/34

(52) U.S. Cl. CPC G01N 30/7233; G01N 30/06; G01N 30/34; G01N 2030/045

(57) ABSTRACT

The present disclosure provides a method for determining content of olaflur in toothpaste by liquid chromatography-tandem mass spectrometry, comprising the following steps: obtaining to-be-tested toothpaste; dissolving the to-be-tested toothpaste in water and then adding methanol for dilution to obtain a to-be-tested solution; and placing the to-be-tested solution in a liquid chromatograph for determination under following chromatographic conditions: a C4 column; a mobile phase as a combination of phase A being methanol with 0.1% formic acid and phase B being acetonitrile, or a combination of phase A being methanol with 0.1% formic acid and phase B being water; and isocratic or gradient elution. The method can analyze the purity of organic olaflur in fluoride-containing anti-caries toothpaste and olaflur raw materials, and enables quantitative analysis of olaflur by an internal or internal standard method. Furthermore, the method can accurately and qualitatively identify olaflur through characteristic ions.

### TECHNICAL FIELD

The present disclosure relates to a liquid chromatography determination method, and in particular, to a method for determining content of olaflur in toothpaste by liquid chromatography-tandem mass spectrometry.

### BACKGROUND

There is currently a standard Determination of Soluble Fluoride for Oral Care Products with Olaflur as a Source of Fluoride for determining the content of fluoride ions (F⁻) in a tested product by ion chromatography with a sodium hydroxide solution for extraction and the fluoride ions as external standard substances, but this method cannot identify whether the tested fluoride source is inorganic fluoride or olaflur. In addition, there is no direct method or standard on the market to determine the presence of olaflur, an organic compound (C₂₇H₆0F₂N₂O₃), in toothpaste. Therefore, it is difficult to effectively identify whether children's toothpaste contains olaflur.

Therefore, methods for identifying and quantifying organic olaflur are urgently needed.

### SUMMARY

The objective of the present disclosure is to provide a method for determining content of olaflur in toothpaste by liquid chromatography-tandem mass spectrometry, which can analyze the purity of organic olaflur in fluoride-containing anti-caries toothpaste and olaflur raw materials, and enables quantitative analysis of olaflur by an external or internal standard method.

To achieve the above objective, this technical solution provides a method for determining content of olaflur in toothpaste by liquid chromatography-tandem mass spectrometry, including the following steps:

obtaining to-be-tested toothpaste;

dissolving the to-be-tested toothpaste in water and then adding methanol for dilution to obtain a to-be-tested solution; and

placing the to-be-tested solution in a liquid chromatograph for determination under following chromatographic conditions: a C4 column; a mobile phase as a combination of phase A being methanol with 0.1% formic acid and phase B being acetonitrile, or a combination of phase A being methanol with 0.1% formic acid and phase B being water; and isocratic or gradient elution.

It should be noted that, as mentioned in the background, current methods for determining fluoride in toothpaste are based on inorganic fluoride, for example, soluble or free fluoride in fluoride-containing anti-caries toothpaste is determined by an ion meter or ion chromatography, or total fluoride is determined by a gas chromatograph. However, such methods, which determine the concentration of fluoride ions (F⁻), cannot identify inorganic fluoride such as sodium fluoride and sodium monofluorophosphate or organic fluoride such as olaflur. In addition, the non-volatile olaflur is not suitable for determination by gas chromatography or gas chromatography-mass spectrometry in the prior art, and olaflur has no absorption peaks under liquid chromatography-ultraviolet or fluorescence in the absence of characteristic groups such as conjugated systems or rigid planar structures.

The chemical formula in FIG. 1 corresponds to organic olaflur (C₂₇H₆0F₂N₂O₃), with a long hydrophobic group (long-chain alkane) and three hydrophilic hydroxyl groups. As a result, olaflur exhibits strong retention and cannot be eluted on an ordinary C18 column. Therefore, this technical solution selects and optimizes a chromatographic column based on its structural characteristics.

In some examples, this technical solution can qualitatively and quantitatively determine olaflur.

When this technical solution is only used for qualitatively determining olaflur, retention time and characteristic ions of a sample chromatogram obtained by the liquid chromatograph are compared with those of an olaflur standard for qualitative determination. In some examples, given that a relative deviation between the retention time of the sample chromatogram and the retention time of the olaflur standard is not more than 5%, relative abundance of characteristic ions in the sample chromatogram is consistent with that of the olaflur standard, and a relative abundance deviation of characteristic ions in the sample chromatogram does not exceed a maximum allowable deviation, it is determined that the to-be-tested toothpaste contains olaflur.

Specifically, the maximum allowable deviation of the relative abundance deviation of characteristic ions in the sample chromatogram is shown in Table 1 below:

Table 1 Maximum allowable deviation of relative abundance deviation of characteristic ions in sample chromatogram

| | | | | |
|---|---|---|---|---|
| Relative ion | >50% | 20%-50% | 10%-20% | ≤10% |
| abundance | | | | |
| Allowable relative | ±20% | ±25% | ±30% | ±50% |
| deviation | | | | |

When this technical solution is used for quantitatively determining olaflur, an external or internal standard method can be used for quantification. When this technical solution uses the external standard method for quantitatively determining olaflur, an olaflur standard is dissolved in a methanol solution to obtain olaflur standard solutions with different concentrations, and the olaflur standard solutions are determined under same chromatographic and mass-spectrometric conditions. Based on determination results, a standard concentration-response intensity curve is drawn to record a relationship between olaflur concentration and response intensity; and the content of olaflur is obtained based on the standard concentration-response intensity curve according to the response intensity of the to-be-tested solution in the liquid chromatograph.

Specifically, when the external standard method is used to quantitatively determine olaflur in the to-be-tested toothpaste, approximately 1-2 g of the to-be-tested toothpaste is added to a polyethylene plastic centrifuge tube and dissolved in ultra-pure water to a volume of 10-50 mL to prepare a sample treatment solution A, and then 100-200 μL of the sample treatment solution A is placed in a polyethylene plastic volumetric flask and diluted with methanol to a certain volume for instrumental analysis.

When the standard concentration-response intensity curve is drawn, the olaflur standard is dissolved in methanol to prepare a 1,000 mg/L standard stock solution C, a certain volume of the standard stock solution C is pipetted into a volumetric flask to prepare an intermediate solution D with a certain concentration, and different volumes of the intermediate solution D are pipetted to prepare olaflur standard solutions with concentrations of 10 to 1,000 μg/L for instrumental analysis.

Of course, same liquid chromatographic conditions for determining the to-be-tested toothpaste and drawing the standard concentration-response intensity curve should be ensured.

When this technical solution uses the internal standard method for quantitatively determining olaflur, an olaflur-D8 internal standard is dissolved in water or a methanol solution to prepare an olaflur internal standard solution, an olaflur standard is dissolved in a methanol solution to obtain an olaflur standard solution, and the olaflur internal standard solution is mixed with the olaflur standard solution to obtain mixed olaflur internal standard solutions with different concentrations. The mixed olaflur internal standard solutions are determined under the same chromatographic and mass-spectrometric conditions, and a concentration ratio-response intensity ratio curve is drawn based on determination results and a relative correction factor; the to-be-tested toothpaste is dissolved in water, then methanol is added for dilution, the olaflur-D8 internal standard is added to obtain a to-be-tested solution, and the content of olaflur is obtained based on a concentration of the to-be-tested solution in the liquid chromatograph and the concentration ratio-response intensity ratio curve.

Regarding the olaflur-D8 internal standard in this technical solution, olaflur-D8 refers to a deuterated isotope-labeled internal standard of olaflur, and its specific chemical formula is as follows:

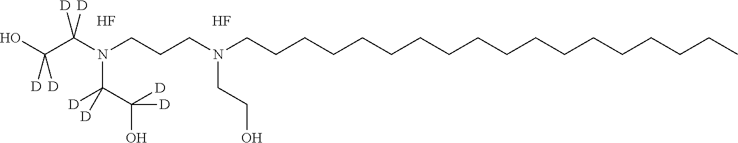

Specifically, a formula for calculating the content of olaflur is as follows:

$$X = \frac{C \times f \times F \times v \times 10}{m \times 1000 \times 1000} \times \frac{38}{498.5} ;$$

where X represents the content of fluoride in olaflur, in %; C represents the measured concentration of olaflur, in μg/L; f represents the relative correction factor of the internal standard method; F represents a dilution factor; v represents a final volume, in mL; 38/498.5 represents a conversion factor of two fluorides in olaflur; and m represents a mass of the to-be-tested toothpaste, in g.

Specifically, when the internal standard method is used to quantitatively determine olaflur, approximately 1-2 g of the to-be-tested toothpaste is added to a polyethylene plastic centrifuge tube and dissolved in ultra-pure water to a volume of 10-50 mL to prepare a sample treatment solution A, and then 100-200 μL of the sample treatment solution A is placed in a polyethylene plastic volumetric flask and diluted with methanol to a certain volume. Subsequently, the internal standard D8-olaflur is added to the diluted solution and shaken well to prepare an intermediate treatment sample B, and 0-50 μL of the intermediate treatment sample B is placed in a polyethylene plastic volumetric flask, diluted with methanol to reach a scale. The solution is shaken well and filtered with a 0.22 μm nylon filter membrane for sample analysis.

When the concentration ratio-response intensity ratio curve is drawn, the olaflur-D8 internal standard is dissolved in methanol or water to prepare a 1,000 mg/L standard stock solution E, the olaflur standard is dissolved in methanol to prepare a 1,000 mg/L standard stock solution C, the standard stock solution C and the standard stock solution E are placed in a volumetric flask to prepare an intermediate solution F with certain concentration, and different volumes of the intermediate solution F are taken to prepare standard working solutions with olaflur and olaflur-D8 concentrations of 10-1,000 μg/L respectively for instrumental analysis.

Of course, same chromatographic and mass-spectrometric conditions for determining the to-be-tested toothpaste and drawing the concentration ratio-response intensity ratio curve should be ensured.

In addition, it should be noted that when the content of olaflur in the to-be-tested toothpaste exceeds a linear range, the to-be-tested solution should be further diluted to ensure that the content of olaflur in the to-be-tested solution is within a calibration curve range of 10-1,000 μg/L.

In addition, in some examples, for the chromatographic conditions of the liquid chromatograph, the C4 column may be referred to but not limited to 50 mm×2.1 mm, 3 μm; the mobile phase may be a combination of phase A being methanol with 0.1% formic acid and phase B being acetonitrile, or a combination of phase A being methanol with 0.1% formic acid and phase B being water; the elution may be isocratic or gradient elution; a flow rate is 0.2-0.6 mL/min; and a column temperature is 30-40° C.

Specifically, when the mobile phase is a combination of phase A being methanol with 0.1% formic acid and phase B being acetonitrile, this technical solution preferably uses 70-90% of phase A and 30-10% of phase B; when the mobile phase is a combination of phase A being methanol with 0.1% formic acid and phase B being water, this technical solution preferably uses 70-90% of phase A and 30-10% of phase B.

In addition, in a specific example, reference gradient conditions are as follows: within 0 min-1 min, the percentage of phase A ranges from 60%-90%; within 1.1 min-3.5 min, the percentage of phase A is 90%; within 3.6 min-5.5 min, the percentage of phase A is 60%.

In other examples, mass-spectrometric conditions for the liquid chromatograph are as follows: a liquid chromatograph-tandem mass spectrometer; an ion source ESI+; an ion source voltage of 5,500 V; curtain gas at 35 psi; an ion source temperature of 500° C.; spray gas GS1 at 50 psi; and auxiliary heating gas GS2 at 50 psi.

Mass-spectrometric parameters for determining the to-be-tested solution in the liquid chromatograph are shown in Table 2 below:

TABLE 2
Mass-spectrometric parameters

| | | | | | Quantitative |
|---|---|---|---|---|---|
| Target | CAS | Ion pair m/z | CE | DP | method |
| Olaflur | 6818-37-7 | 459.5/354.3* | 37.1 | 20 | External or |
| | | 459.5/146.4 | 34.0 | 20 | internal |
| D8-olaflur | / | 467.4/354.4* | 40.9 | 80 | standard |
| | | 467.4/154.2 | 36.3 | 80 | method |

In a second aspect, this technical solution provides a use of the method for determining the content of olaflur in toothpaste by liquid chromatography-tandem mass spectrometry, for determining the content of olaflur in toothpaste.

Compared with the prior art, this technical solution has the following characteristics and beneficial effects:

This technical solution uses liquid chromatography to determine organic olaflur in toothpaste and uses the external or internal standard method for quantitative analysis, which can not only achieve accurate qualitative identification of olaflur through characteristic ions, but also achieve quantitative analysis by the external or internal standard method.

### BRIEF DESCRIPTION OF THE DRAWINGS

FIG. 1 is a schematic view distinguishing a method for determining content of olaflur in toothpaste by liquid chromatography-tandem mass spectrometry in the present disclosure and determination of fluorides in the prior art.

FIG. 2 to FIG. 4 are chromatograms of Examples 1 to 3.

FIG. 5 is a chromatogram of Comparative Example 1.

FIG. 6 to FIG. 12 are chromatograms of Examples 4 to 10.

FIG. 13 to FIG. 17 are chromatograms of Examples 11 to 15.

FIG. 18 is a chromatogram of Example 16.

FIG. 19 is a chromatogram of Example 17.

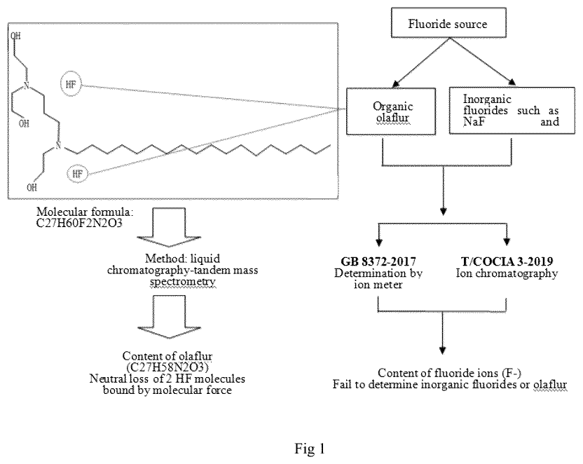

### DETAILED DESCRIPTION OF THE EMBODIMENTS

The technical solutions in the examples of the present disclosure will be clearly and completely described below in conjunction with the accompanying drawings therein. Apparently, the described examples are only some, not all of the examples of the present disclosure. All other examples obtained by a person of ordinary skill in the art based on the examples of the present disclosure fall within the scope of protection of the present disclosure.

1. Experiments with Different Chromatographic Columns

### Example 1

An olaflur standard was added to a polyethylene plastic centrifuge tube and dissolved in methanol to a volume of 10 mL to prepare a sample treatment solution A, and 20 μL of the sample treatment solution A was placed in a polyethylene plastic volumetric flask and diluted with methanol to a volume of 10 mL to obtain a treatment solution B. 100-1,000 μL of the treatment solution B was further diluted with methanol to an appropriate concentration for instrumental analysis.

Mass-spectrometric conditions: a liquid chromatograph-tandem mass spectrometer; an ion source ESI+; an ion source voltage of 5,500 V; curtain gas at 35 psi; an ion source temperature of 500° C.; spray gas GS1 at 50 psi; and auxiliary heating gas GS2 at 50 psi.

Chromatographic conditions: a C4 column (50 mm×2.1 mm, 3 μm); a mobile phase as a combination of phase A being methanol with 0.1% formic acid and phase B being water; a flow rate of 0.2-0.6 mL/min; and a column temperature of 30-40° C.

### Example 2

All conditions were the same as Example 1, except that a C8 column was used.

### Example 3

All conditions were the same as Example 1, except that a C18 column was used.

### Comparative Example 1

An olaflur standard was added to a polyethylene plastic centrifuge tube and dissolved in ultra-pure water to a volume of 10 mL to prepare a sample treatment solution, and 20-50 μL of the sample treatment solution was placed in a polyethylene plastic volumetric flask and diluted with methanol to a volume of 10 mL for instrumental analysis. Liquid chromatographic conditions were the same as Example 1.

### Analysis of Test Results;

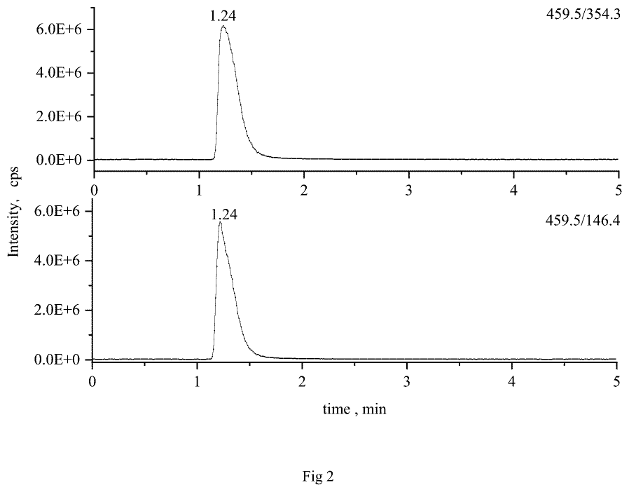

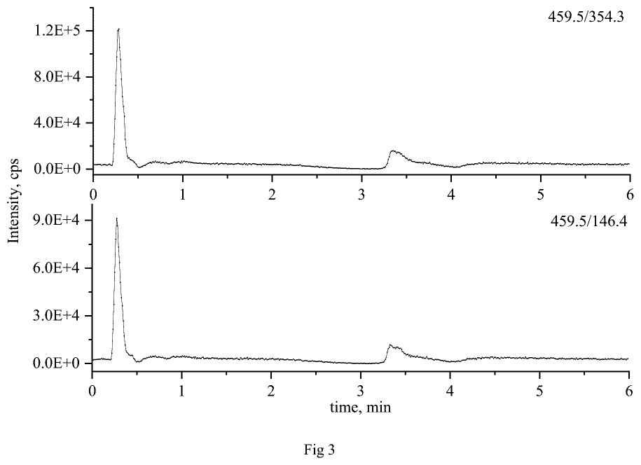

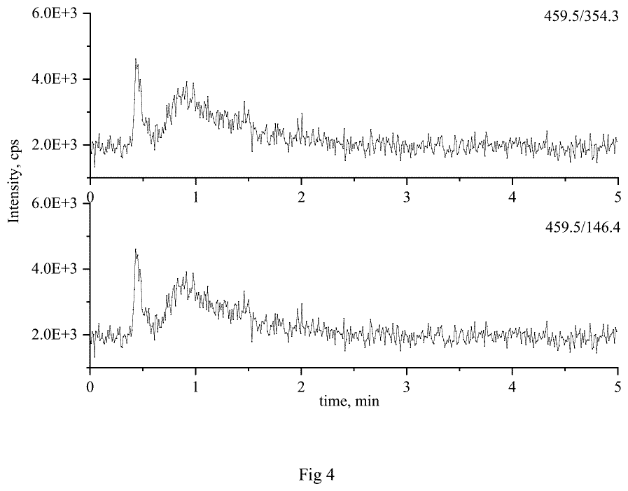

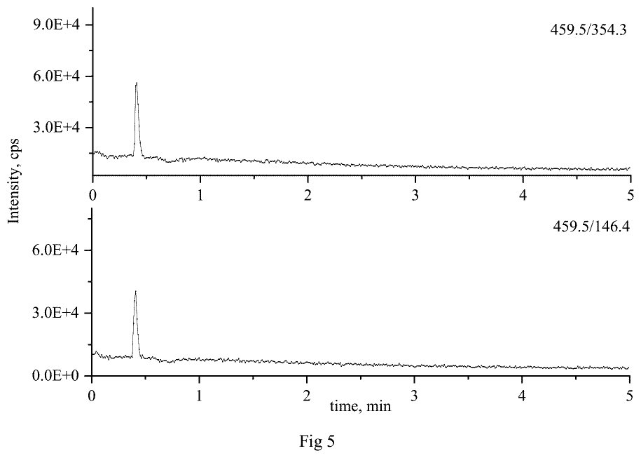

FIG. 2 is a chromatogram corresponding to Example 1, showing that the appearance time of olaflur was 1.24 min. Its retention time can be changed by adjusting the proportion of the mobile phase. FIG. 3 is a chromatogram corresponding to Example 2, showing the retention time of 3.33 min, accompanied by low peak response intensity and poor peak shape. FIG. 4 is a chromatogram corresponding to Example 3, showing no peaks and indicating that olaflur was not eluted with different chromatographic solvents. FIG. 5 is a chromatogram of blank methanol.

2. Experiments with Different Mobile Phases:

### Example 4

An olaflur standard was added to a polyethylene plastic centrifuge tube and dissolved in methanol to a volume of 10 mL to prepare a sample treatment solution A, and 20 μL of the sample treatment solution A was placed in a polyethylene plastic volumetric flask and diluted with methanol to a volume of 10 mL to obtain a treatment solution B. 100-1,000 μL of the treatment solution B was further diluted with methanol to an appropriate concentration for instrumental analysis.

Mass-spectrometric conditions: a liquid chromatograph-tandem mass spectrometer; an ion source ESI+; an ion source voltage of 5,500 V; curtain gas at 35 psi; an ion source temperature of 500° C.; spray gas GS1 at 50 psi; and auxiliary heating gas GS2 at 50 psi.

Chromatographic conditions: a C4 column (50 mm×2.1 mm, 3 μm); a mobile phase as methanol and water for isocratic elution; a flow rate of 0.2-0.6 mL/min; and a column temperature of 30-40° C.

### Example 5

All conditions were the same as Example 4, except that the mobile phase contained methanol with 0.1% formic acid and water.

### Example 6

All conditions were the same as Example 4, except that the mobile phase contained acetonitrile with 0.1% formic acid and water.

### Example 7

All conditions were the same as Example 4, except that the mobile phase contained 90% of methanol with 0.1% formic acid and 10% of acetonitrile with 0.1% formic acid.

### Example 8

All conditions were the same as Example 4, except that the mobile phase contained 90% of methanol and 10% of 0.1% acetonitrile with 0.1% formic acid.

### Example 9

All conditions were the same as Example 4, except that the mobile phase contained 80% of methanol with 0.1% formic acid and 20% of acetonitrile with 0.1% formic acid.

### Example 10

All conditions were the same as Example 4, except that the mobile phase contained 50% of methanol with 0.1% formic acid and 50% of acetonitrile with 0.1% formic acid.

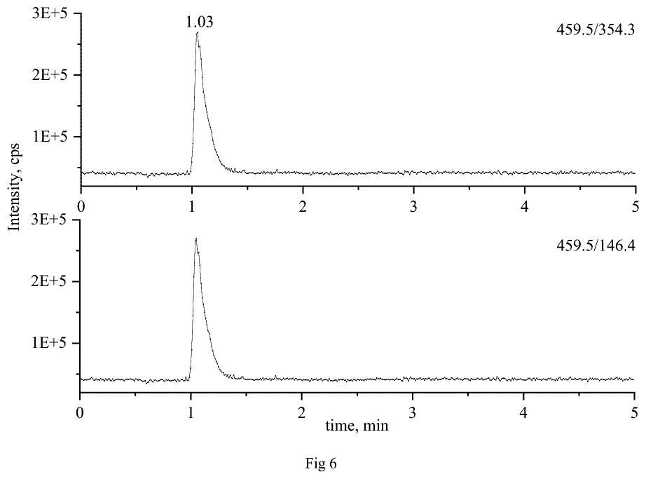

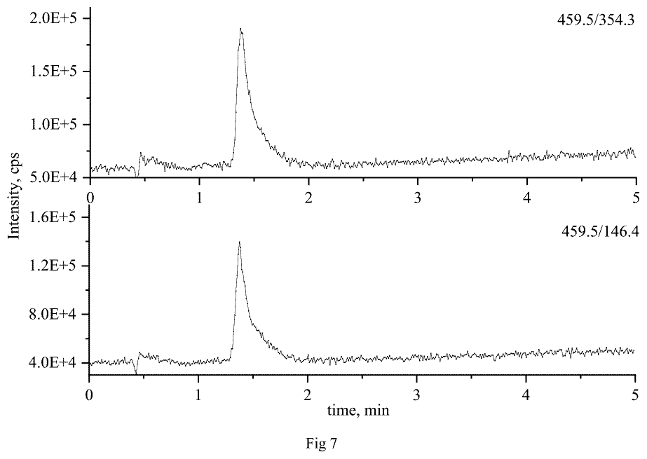

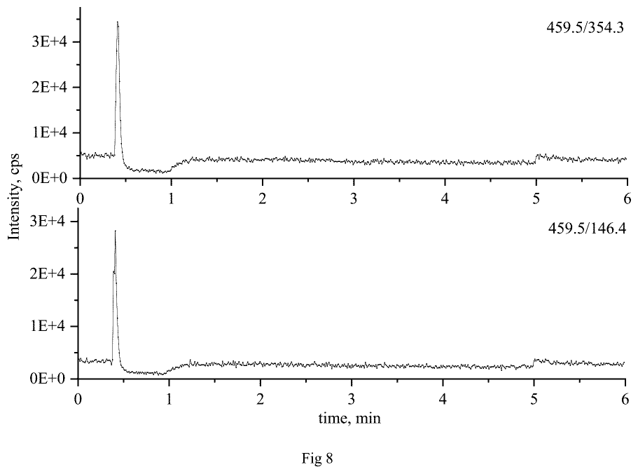

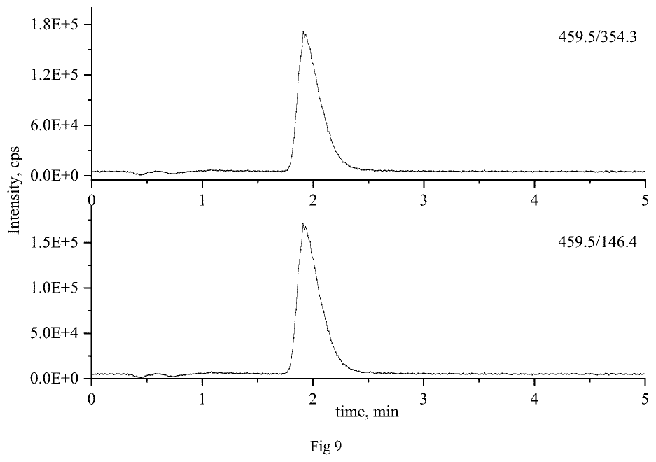

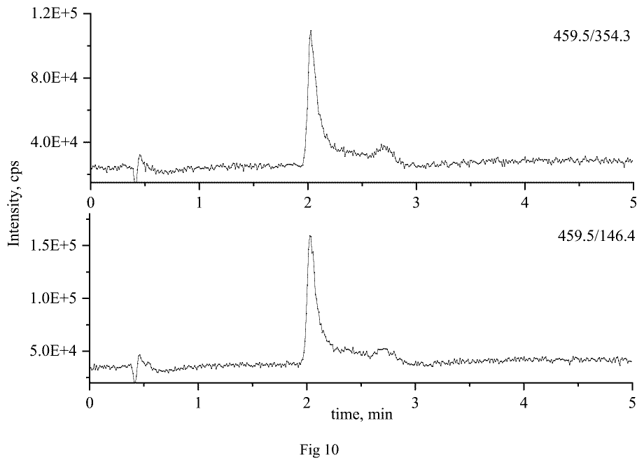

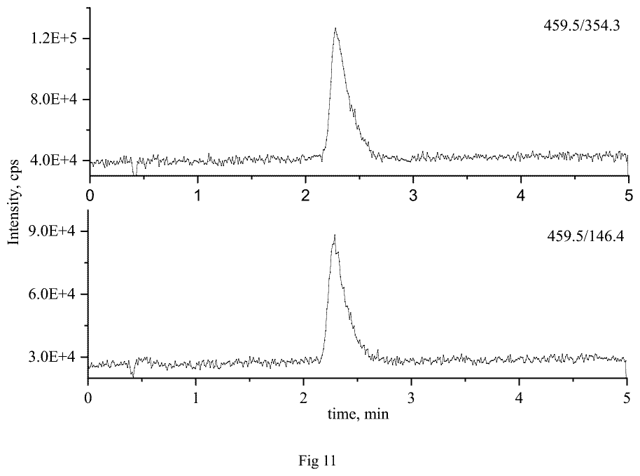

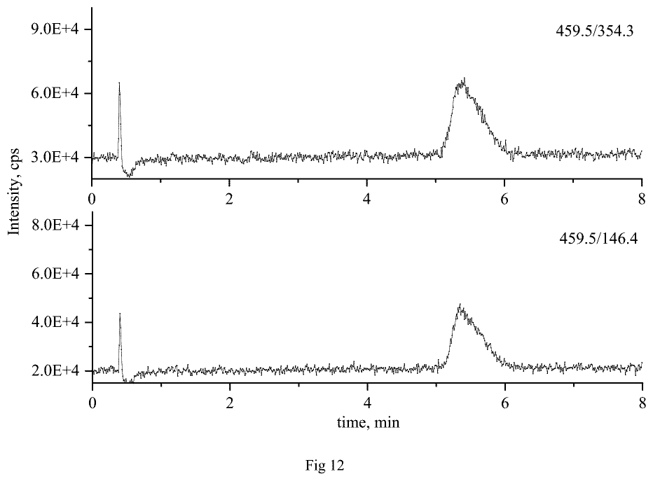

Chromatograms obtained in Examples 4 to 10 are shown in FIGS. 6 to 12, respectively: peaks appeared when the mobile phase contained methanol and methanol with 0.1% formic acid, while no peak appeared when acetonitrile with 0.1% formic acid was selected as the mobile phase; when 90% of methanol and 10% of acetonitrile with 0.1% formic acid were selected, there was obvious peak tailing; when 80% of methanol with 0.1% formic acid and 20% of acetonitrile with 0.1% formic acid were selected, the retention time increased with the increase of acetonitrile proportion, showing that the increase in the proportion of acid in the mobile phase improved the peak shape; and when 50% of methanol with 0.1% formic acid and 50% of acetonitrile with 0.1% formic acid were selected, the peak widened significantly.

### Example 11

An olaflur standard was added to a polyethylene plastic centrifuge tube and dissolved in methanol to a volume of 10 mL to prepare a sample treatment solution A, and 20 μL of the sample treatment solution A was placed in a polyethylene plastic volumetric flask and diluted with methanol to a volume of 10 mL to obtain a treatment solution B. 100-1,000 μL of the treatment solution B was further diluted with methanol to an appropriate concentration for instrumental analysis.

Mass-spectrometric conditions: a liquid chromatograph-tandem mass spectrometer; an ion source ESI+; an ion source voltage of 5,500 V; curtain gas at 35 psi; an ion source temperature of 500° C.; spray gas GS1 at 50 psi; and auxiliary heating gas GS2 at 50 psi.

Chromatographic conditions: a C4 column (50 mm×2.1 mm, 3 μm); a mobile phase as a combination of phase A being methanol with 0.1% formic acid and phase B being acetonitrile; a flow rate of 0.2-0.6 mL/min; and a column temperature of 30-40° C.

Gradient conditions were set as shown in Table 3 below:

TABLE 3
Gradient conditions

| Time (min) | A (%) | B (%) |
|---|---|---|
| 0.1 | 30 | 70 |
| 2.0 | 90 | 10 |
| 5.0 | 90 | 10 |
| 5.1 | 30 | 70 |
| 8.0 | 30 | 70 |

### Example 12

All conditions were the same as Example 11, except that the gradient conditions were set as shown in Table 4 below:

TABLE 4
Gradient conditions

| Time (min) | A (%) | B (%) |
|---|---|---|
| 0.1 | 50 | 50 |
| 0.5 | 90 | 10 |
| 4.0 | 90 | 10 |
| 4.1 | 50 | 50 |
| 6.0 | 50 | 50 |

### Example 13

All conditions were the same as Example 11, except that the gradient conditions were set as shown in Table 5 below:

TABLE 5
Gradient conditions

| Time (min) | A (%) | B (%) |
|---|---|---|
| 0.1 | 40 | 60 |
| 1.5 | 80 | 20 |
| 4.5 | 80 | 20 |
| 4.6 | 40 | 60 |
| 6.0 | 40 | 60 |

### Example 14

All conditions were the same as Example 11, except that water was used as phase B of the mobile phase.

### Example 15

All conditions were the same as Example 11, except that acetonitrile was used as phase B of the mobile phase.

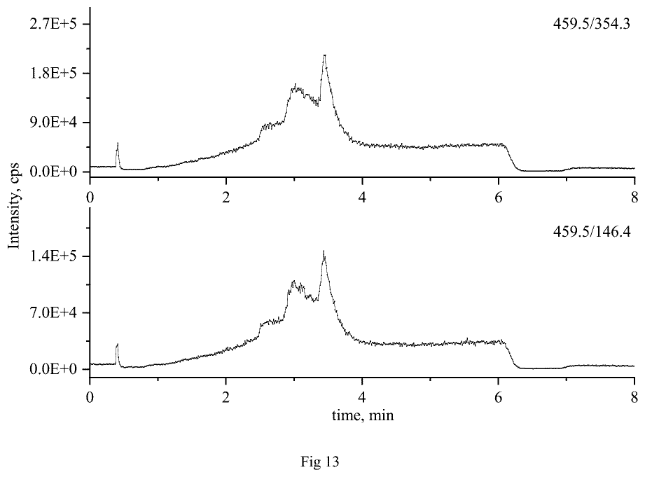

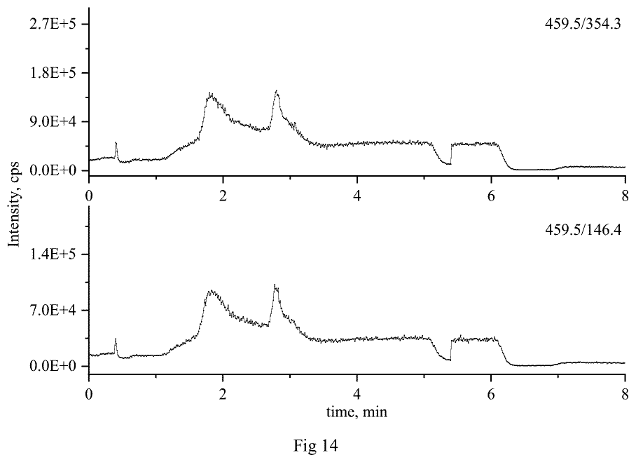

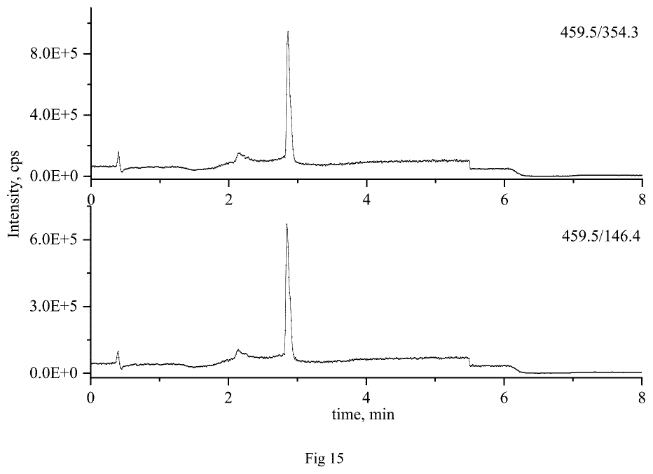

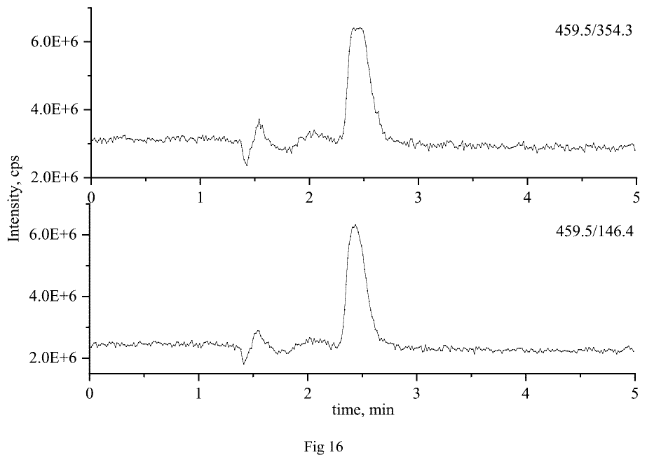

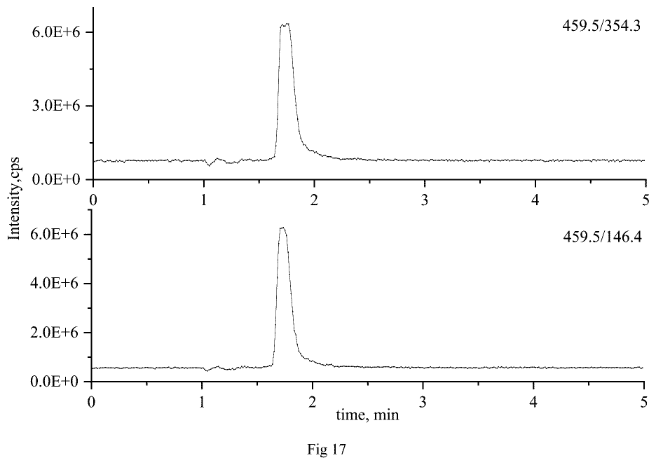

Chromatograms obtained in Examples 11 to 15 are shown in FIGS. 13 to 17, respectively. From FIGS. 13, 16, and 17, it can be seen that acetonitrile had a better effect of improving the peak shape and peak response intensity of olaflur than water.

### 3. Determination of Olaflur in Toothpaste by an External Standard Method

### Example 16

An olaflur standard was added to a polyethylene plastic centrifuge tube and dissolved in methanol to a volume of 10 mL to prepare a sample treatment solution A, and 20 μL of the sample treatment solution A was placed in a polyethylene plastic volumetric flask and diluted with methanol to a volume of 10 mL to obtain a treatment solution B. 100-1,000 μL of the treatment solution B was further diluted with methanol to an appropriate concentration for instrumental analysis.

Mass-spectrometric conditions: a liquid chromatograph-tandem mass spectrometer; an ion source ESI+; an ion source voltage of 5,500 V; curtain gas at 35 psi; an ion source temperature of 500° C.; spray gas GS1 at 50 psi; and auxiliary heating gas GS2 at 50 psi.

Chromatographic conditions: a C4 column (50 mm×2.1 mm, 3 μm); a mobile phase as phase A being methanol with 0.1% formic acid and phase B being water for isocratic elution; a flow rate of 0.2-0.6 mL/min; and a column temperature of 30-40° C.

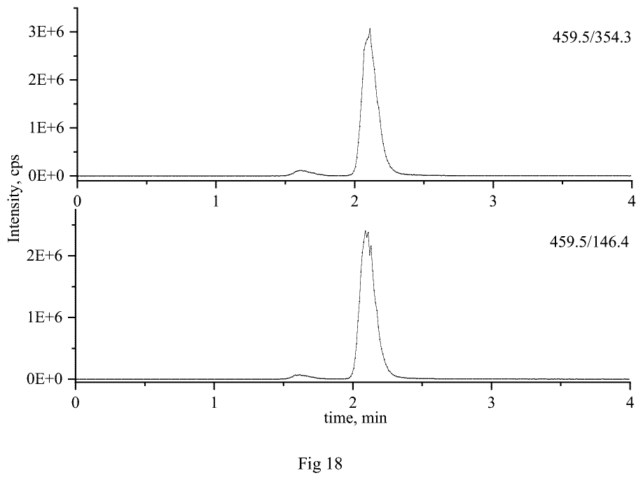

A sample chromatogram obtained in Example 16 is shown in FIG. 18, showing that this technical solution can well determine olaflur in toothpaste.

### 4. Determination of Olaflur in Toothpaste by an Internal Standard Method

### Example 17

When an internal standard method was used to quantitatively determine olaflur, approximately 1-2 g of toothpaste was added to a polyethylene plastic centrifuge tube and dissolved in ultra-pure water to a volume of 10-50 mL to prepare a sample treatment solution A, and then a certain amount (such as 100-200 μL) of the sample treatment solution A was placed in a polyethylene plastic volumetric flask and diluted with methanol to a certain volume. Subsequently, an internal standard D8-olaflur was added to the diluted solution and shaken well to prepare an intermediate treatment sample B, and 0-50 μL of the intermediate treatment sample B was placed in a polyethylene plastic volumetric flask, diluted with methanol to a reach a scale. The solution is shaken well and filtered with a 0.22 μm nylon filter membrane for sample analysis.

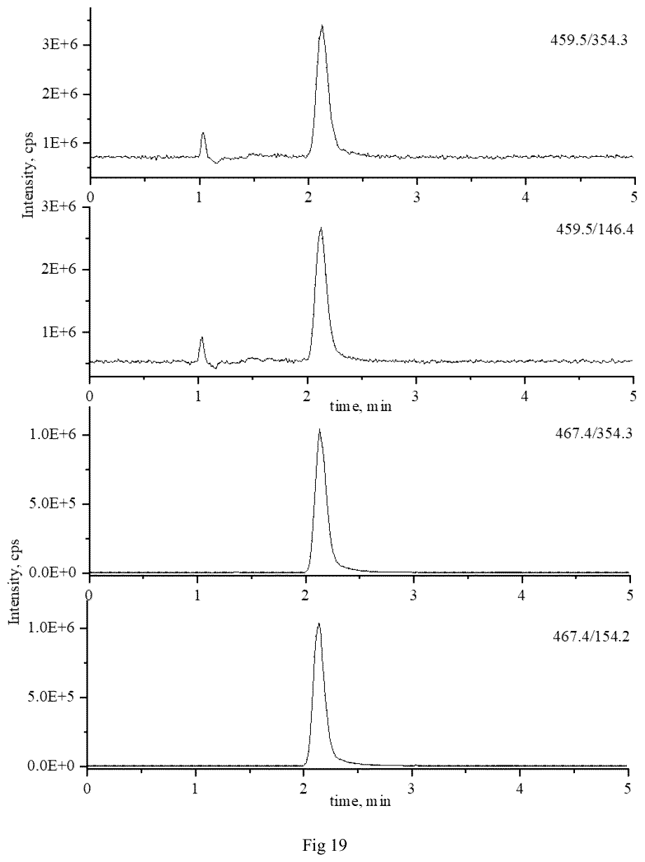

A sample chromatogram obtained in Example 17 is shown in FIG. 19, showing that this technical solution can well determine olaflur in toothpaste.

The present disclosure is not limited to the above best embodiments. Any person can derive other products in various forms under the inspiration of the present disclosure. However, regardless of any change in shape or structure, any other technical solutions that are the same or similar to the technical solutions of the present disclosure fall within the scope of protection of the present disclosure.

1. A method for determining content of olaflur in toothpaste by liquid chromatography-tandem mass spectrometry, comprising the following steps: obtaining to-be-tested toothpaste; dissolving the to-be-tested toothpaste in water and then adding methanol for dilution to obtain a to-be-tested solution; and placing the to-be-tested solution in a liquid chromatograph for determination under following chromatographic conditions: a C4 column; a mobile phase as a combination of phase A being methanol with 0.1% formic acid and phase B being acetonitrile, or a combination of phase A being methanol with 0.1% formic acid and phase B being water; and isocratic or gradient elution; wherein
when an external standard method is used to quantitatively determine olaflur, an olaflur standard is dissolved in a methanol solution to obtain olaflur standard solutions with different concentrations, and the olaflur standard solutions are determined under same chromatographic and mass-spectrometric conditions; based on determination results, a standard concentration-response intensity curve is drawn to record a relationship between olaflur concentration and response intensity; and the content of olaflur is obtained based on the standard concentration-response intensity curve according to the response intensity of the to-be-tested solution in the liquid chromatograph; and
when an internal standard method is used to quantitatively determine olaflur, an olaflur-D8 internal standard is dissolved in water or a methanol solution to prepare an olaflur internal standard solution, an olaflur standard is dissolved in a methanol solution to obtain an olaflur standard solution, and the olaflur internal standard solution is mixed with the olaflur standard solution to obtain mixed olaflur internal standard solutions with different concentrations; the mixed olaflur internal standard solutions are determined under the same chromatographic and mass-spectrometric conditions, and a concentration ratio-response intensity ratio curve is drawn based on determination results and a relative correction factor; the to-be-tested toothpaste is dissolved in water, then methanol is added for dilution, the olaflur-D8 internal standard is added to obtain a to-be-tested solution, and the content of olaflur is obtained based on a concentration of the to-be-tested solution in the liquid chromatograph and the concentration ratio-response intensity ratio curve.

2. The method for determining the content of olaflur in toothpaste by liquid chromatography-tandem mass spectrometry according to claim 1, wherein the mobile phase contains 70-90% of phase A being methanol with 0.1% formic acid and 30-10% of phase B being acetonitrile; or the mobile phase contains 70-90% of phase A being methanol with 0.1% formic acid and 30-10% of phase B being water.

3. The method for determining the content of olaflur in toothpaste by liquid chromatography-tandem mass spectrometry according to claim 1, wherein retention time and characteristic ions of a sample chromatogram obtained by the liquid chromatograph are compared with those of the olaflur standard for qualitative determination.

4. The method for determining the content of olaflur in toothpaste by liquid chromatography-tandem mass spectrometry according to claim 1, wherein a formula for calculating the content of olaflur is as follows:
$$X = \frac{C \times f \times F \times v \times 10}{m \times 1000 \times 1000} \times \frac{38}{498.5} ,$$
wherein X represents the content of fluoride in olaflur; C represents the measured concentration of olaflur; f represents the relative correction factor of the internal standard method; F represents a dilution factor; v represents a final volume; and m represents a mass of the to-be-tested toothpaste.

5. The method for determining the content of olaflur in toothpaste by liquid chromatography-tandem mass spectrometry according to claim 1, wherein a flow rate is 0.2-0.6 mL/min and a column temperature is 30-40° C.

6. The method for determining the content of olaflur in toothpaste by liquid chromatography-tandem mass spectrometry according to claim 1, wherein mass-spectrometric conditions are as follows: an ion source ESI+; an ion source voltage of 5,500 V; curtain gas at 35 psi; an ion source temperature of 500° C.; spray gas GS1 at 50 psi; and auxiliary heating gas GS2 at 50 psi.

7. The method for determining the content of olaflur in toothpaste by liquid chromatography-tandem mass spectrometry according to claim 1, wherein the content of olaflur in the to-be-tested solution is within a calibration curve range of 10-1,000 μg/L.

8. A use of the method for determining the content of olaflur in toothpaste by liquid chromatography-tandem mass spectrometry according to claim 1, for determining the content of olaflur in toothpaste.

9. A use of the method for determining the content of olaflur in toothpaste by liquid chromatography-tandem mass spectrometry according to claim 2, for determining the content of olaflur in toothpaste.

10. A use of the method for determining the content of olaflur in toothpaste by liquid chromatography-tandem mass spectrometry according to claim 3, for determining the content of olaflur in toothpaste.

11. A use of the method for determining the content of olaflur in toothpaste by liquid chromatography-tandem mass spectrometry according to claim 4, for determining the content of olaflur in toothpaste.

12. A use of the method for determining the content of olaflur in toothpaste by liquid chromatography-tandem mass spectrometry according to claim 5, for determining the content of olaflur in toothpaste.

13. A use of the method for determining the content of olaflur in toothpaste by liquid chromatography-tandem mass spectrometry according to claim 6, for determining the content of olaflur in toothpaste.

14. A use of the method for determining the content of olaflur in toothpaste by liquid chromatography-tandem mass spectrometry according to claim 7, for determining the content of olaflur in toothpaste.
